(19) United States
(12) Patent Application Publication
(10) Pub. No.: US 2022/0044317 A1
(43) Pub. Date: Feb. 10, 2022

(54) Mobile Application to Allow Users to Invest in Musical Artist

(71) Applicant: Antonio Bonton, Douglasville, GA (US)

(72) Inventor: Antonio Bonton, Douglasville, GA (US)

(21) Appl. No.: 16/986,081

(22) Filed: Aug. 5, 2020

(51) Int. Cl. G06Q 40/04; G06Q 20/12; G06Q 50/00; G06Q 20/32; G06N 7/00

(52) U.S. Cl. CPC G06Q 40/04; G06Q 20/1235; G06N 7/005; G06Q 20/326; G06Q 50/01

(57) ABSTRACT

The present invention generally is a mobile application that creates a market wherein shares can be bought or sold within its platform in accordance solely with an artist's fan-based popularity according to a specific algorithm in real-time pursuant to current trends and popular opinion.

### FIELD OF THE DISCLOSURE

The present performance based mobile application generally allows its users to directly invest funds in a show of support to a preferred musical artist from its platform.

### BACKGROUND ART

There are several mobile applications that allow users to directly send funds to parties from its platform. However, this mobile application is only in support of the music industry and is a platform designed for the use of fans by fans.

### SUMMARY OF THE DISCLOSURE

This mobile application is designed for mobile operating systems such as iOS and Android. It enables users to view and invest in musical artists by way of an algorithm which utilizes data collected from streaming data, radio plays, YouTube views, and social media participants. Subject to the analysis of the data, a price-point is created for each musical artist which will allow users to buy and/or sell shares. A moving price point is then created as a result of the quantity of users buying and selling within the application wherein a market is thereby constructed.

### BRIEF DESCRIPTION OF THE DRAWINGS

FIG. 1 is the first page of the mobile application where the account is initially created;

FIG. 2 is the second page of the mobile application where the user's credit or debit card information is stored for usage;

FIG. 3 is the “Watchlist” page which reflects the increased/decreased price points of each artist the user has selected as well as the artist's current market value;

FIG. 4 is the “Order Preview” page which reflects a purchase of shares;

FIG. 5 is the “Notifications” page which reflects price points for those watched artist(s);

FIG. 6 is wallpaper images of increased/decreased price points for artist(s);

FIG. 6.1 is wallpaper images of increased/decreased price points for artist(s); and

FIG. 6.2 is wallpaper images of increased/decreased price points for artist(s).

### DETAILED DESCRIPTION OF FIRST EXEMPLARY EMBODIMENT

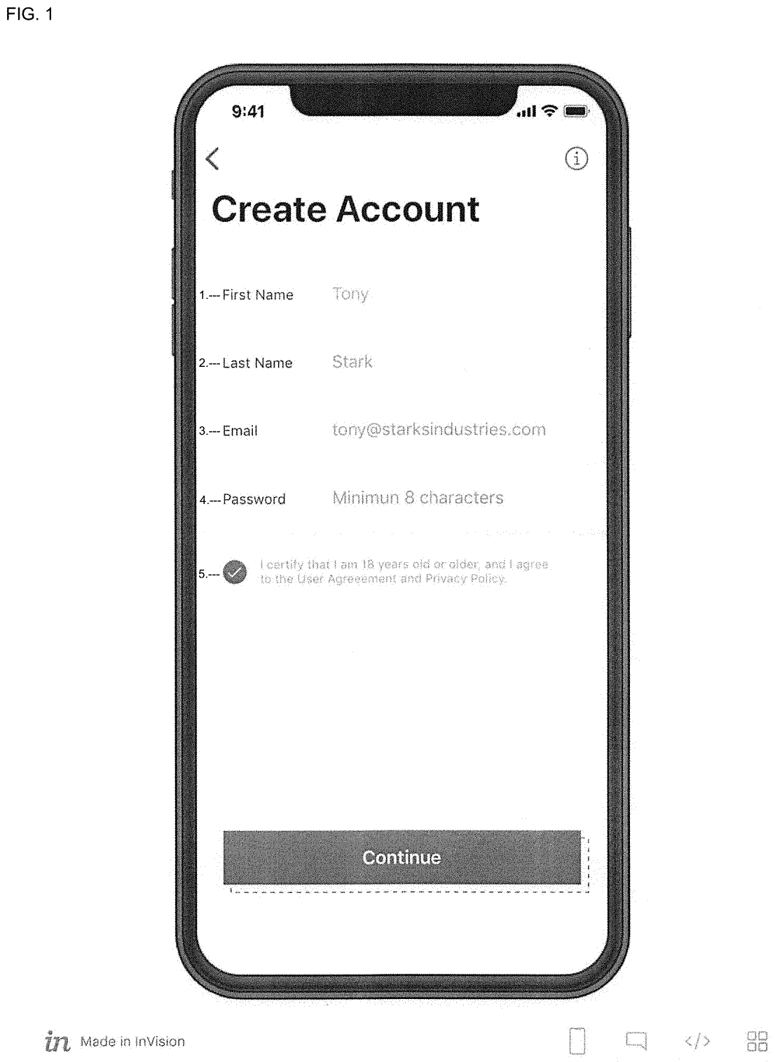

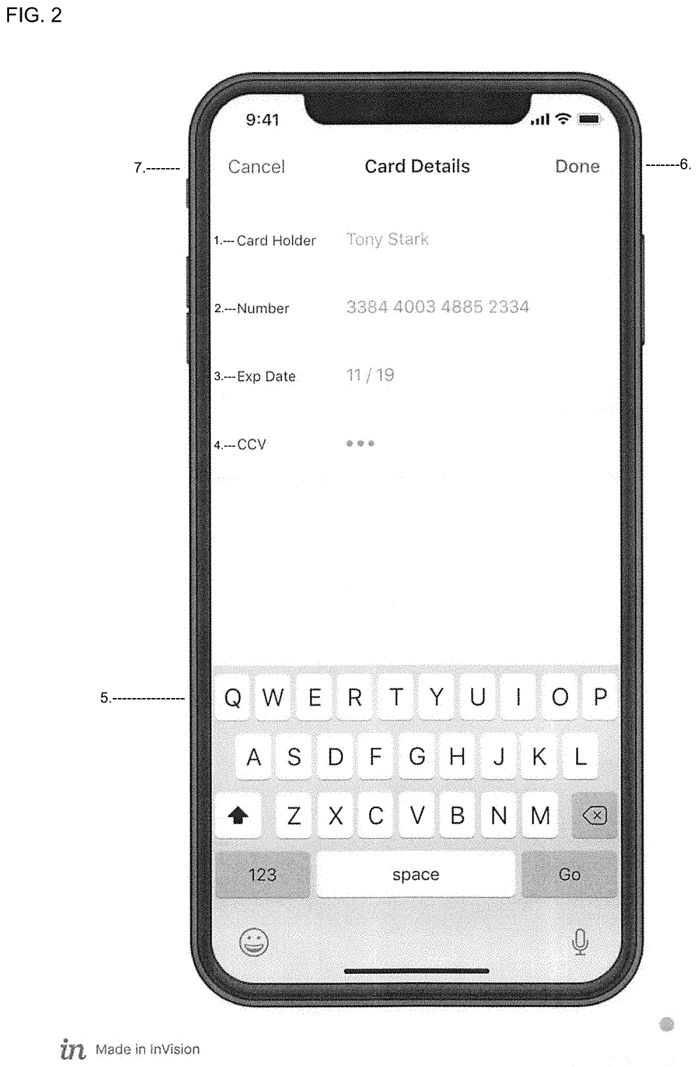

This mobile application is designed to allow users to invest in musical artists in the form of shares established on a market constructed from an algorithm which utilizes data collected from streaming data, radio plays, YouTube views, and social media participants. Initially, the user will “Create an Account” (FIG. 1) which allows access to the platform at the discretion that they must be at least 18 years or older. The user then proceeds to the “Card Details” page (FIG. 2) to input their debit or credit card information that will be used for all transactions over a secured network.

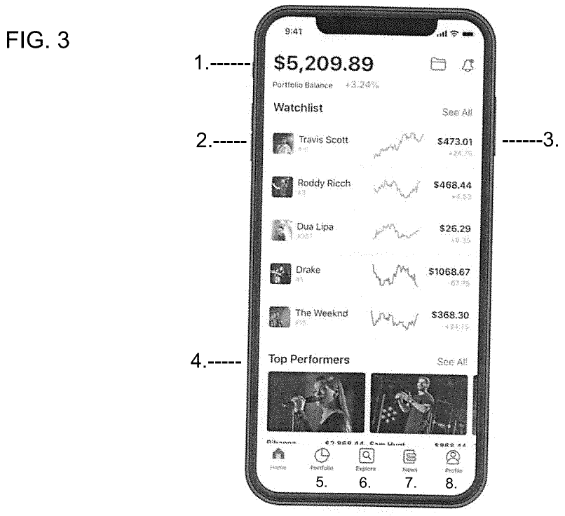

Users will utilize the “Watchlist” page (FIG. 3) to monitor the artists they have selected to invest in. This page provides detail into the artist's current market value and asserts an increased or decreased value to their price point. On this page, users are also able to review and analyze the top performers. At the bottom of the page, users are able to review their portfolio, explore for artists, review the news and update their profile.

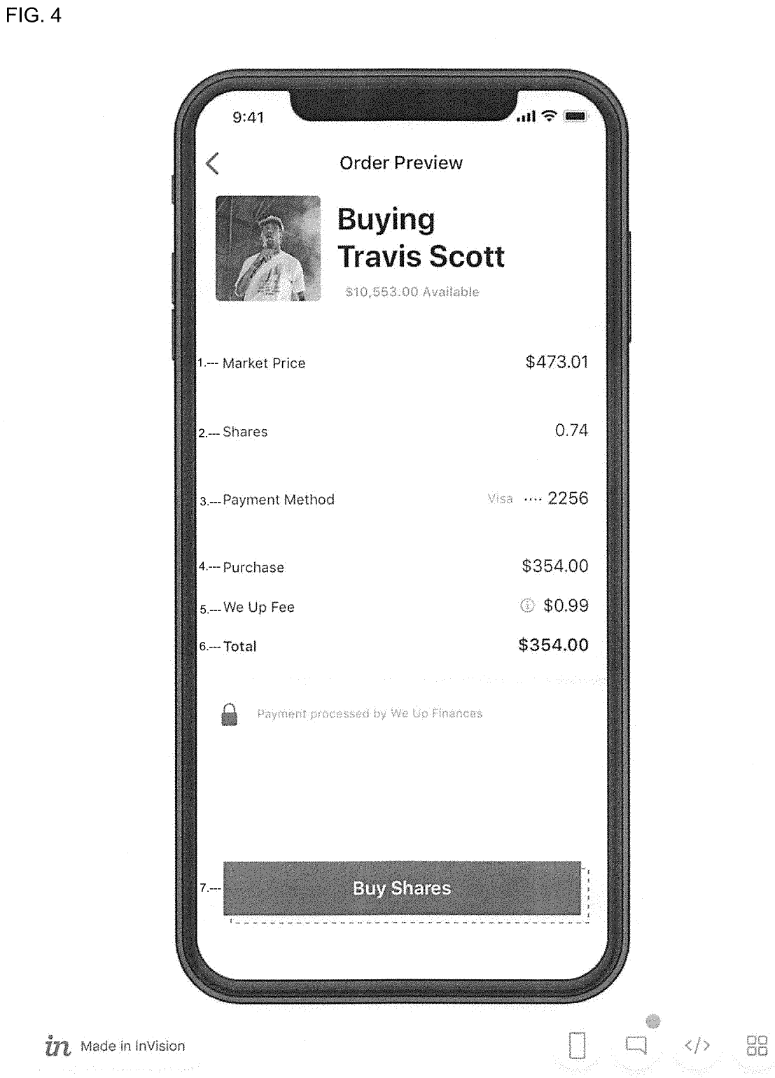

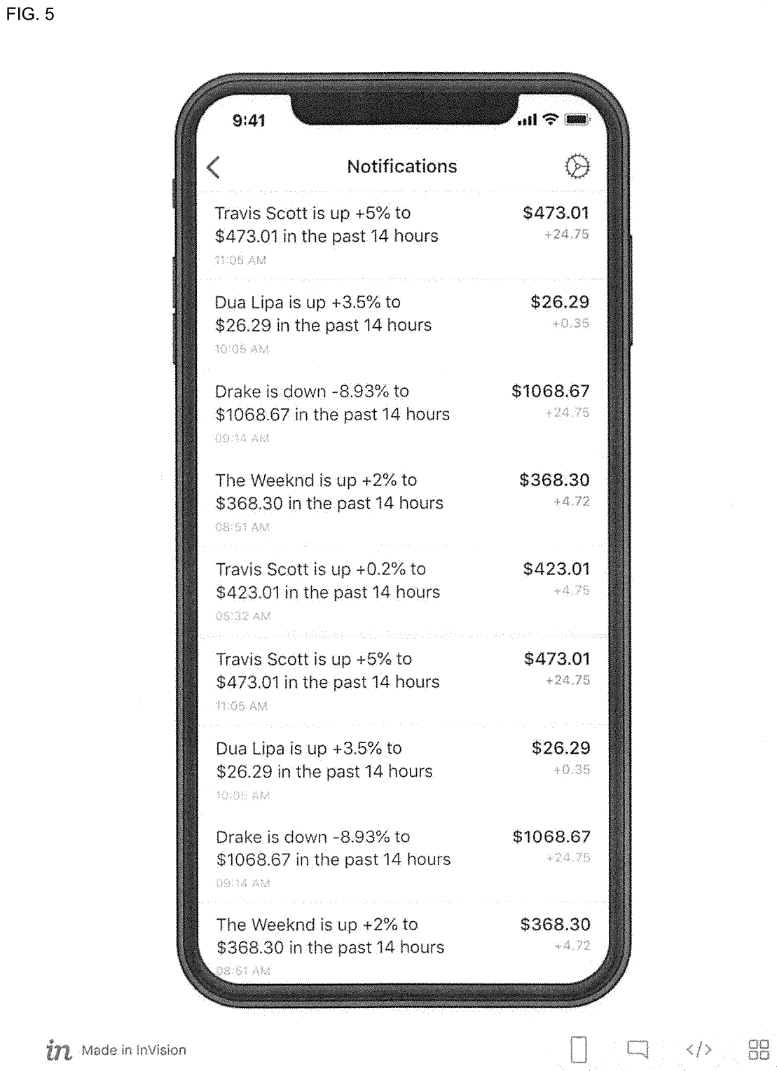

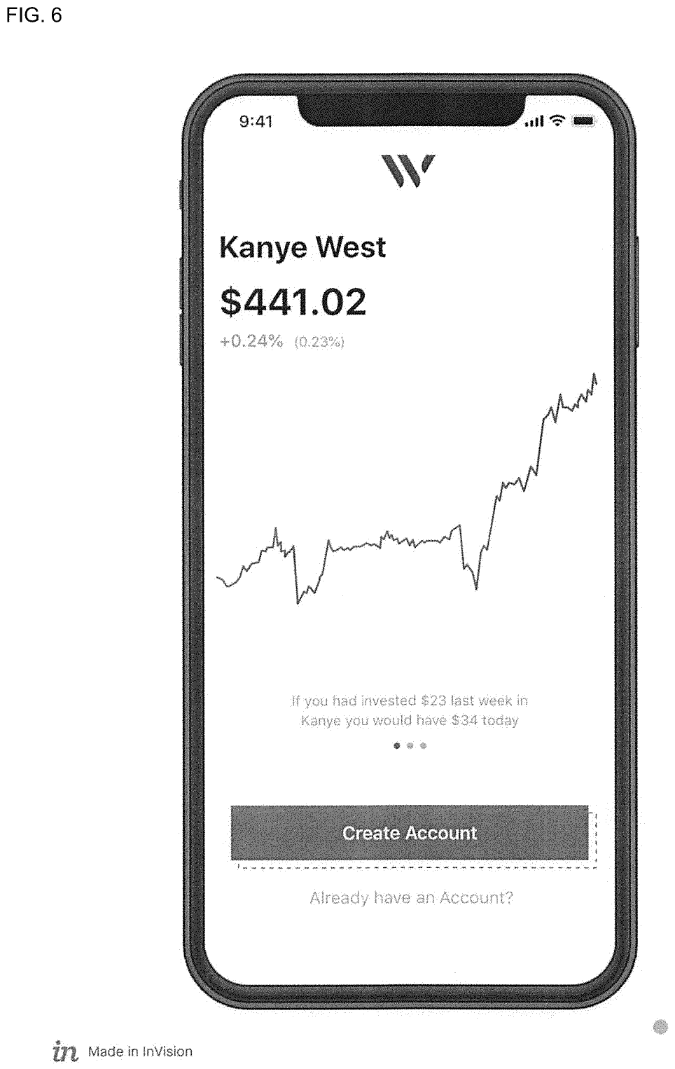

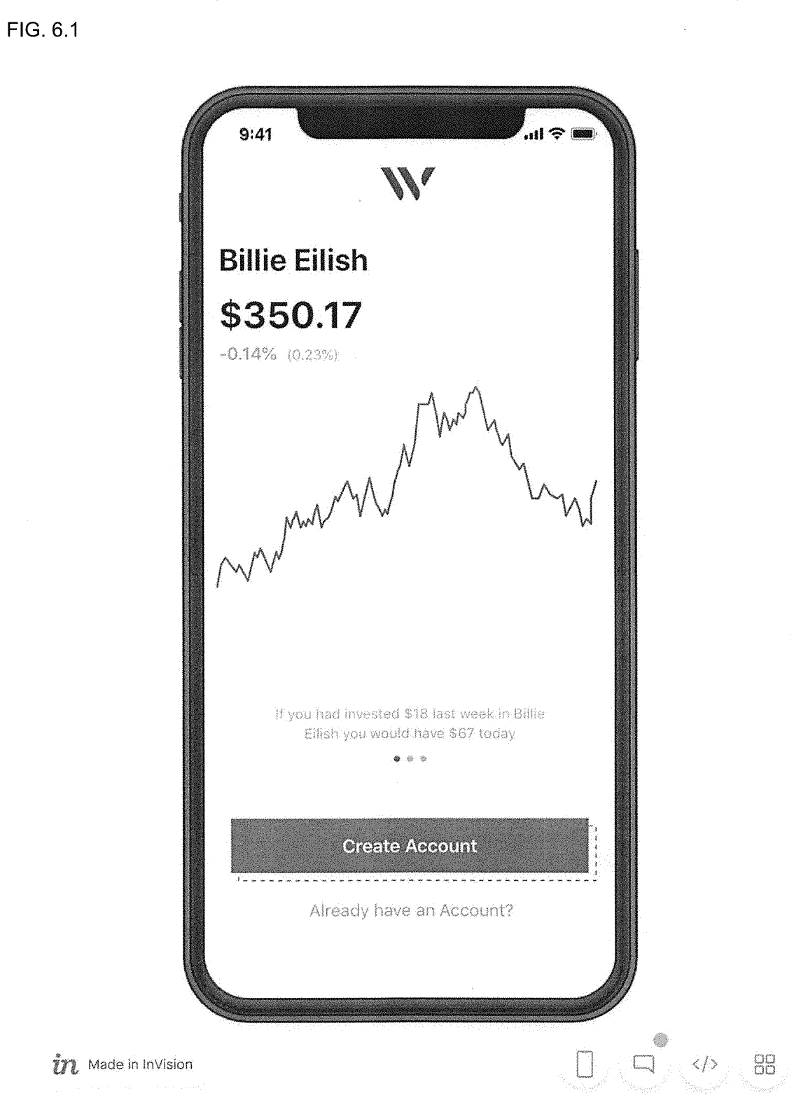

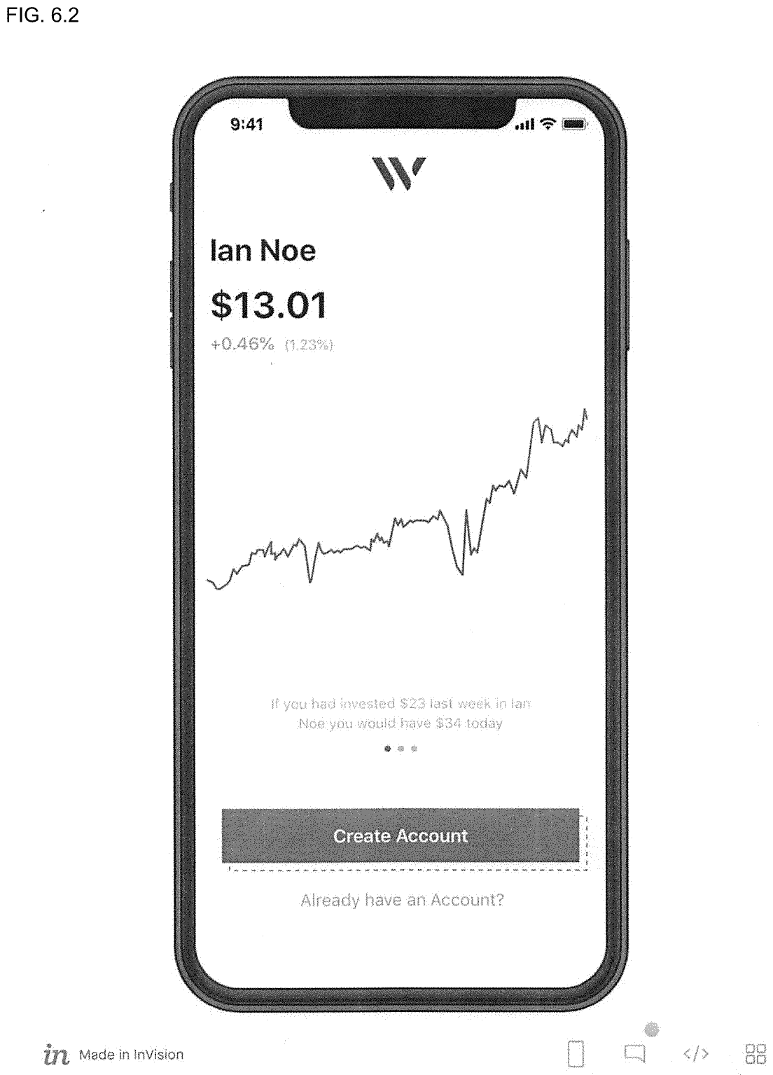

Upon selecting an artist to invest in and placing an order for shares, the “Order Preview” page (FIG. 4) will populate. This page specifically reflects the user's available balance, the artist's market price, the cost per share, payment method, purchase price and fee. After review of all details, the user simply hits the “Buy Shares” button at the bottom. After shares are purchased, the user has the ability to monitor the market by way of the “Notifications” page (FIG. 5) which reflects the ups and downs of the artist's activity on the application as well as their current market price and price points. While a user is not logged in, a wallpaper pop-up option reflects the activity of artists who are currently trending on the application. (FIGS. 6, 6.1, 6.2).

According to one aspect, the embodiments of this invention will consist of an algorithm that monitors fan-based data in real-time in order to accomplish the following, for example:
1. Identify a specific artist that is trending in a negative or positive way based on social media data received in real-time;
2. Determine probabilities and odds for an artist in the market;
3. Create a market for users to invest in and against artists pursuant to their current popularity; and
4. Provide cash outs to the users back into their electronic accounts for sold shares.

1. An apparatus, consisting of at least one processor; and at least one memory having instructions stored thereon which, determine a probability of occurrence for each of the plurality of possible future markets based on probability information and reliability information associated with the probability information; based at least in part on the probabilities, determine increased or decreased value to buy or sell shares that a first one of the plurality of possible future markets will occur; cause to be presented to a plurality of users at a plurality of corresponding computer interfaces information indicating an opportunity to buy or sell shares at the determined value that the first possible future market will occur, the plurality of computer interfaces being in networked communication with the at least one processor; responsive to the act of causing to be presented the information, receive from a first of a plurality of users a first purchase that the first possible future market will occur; and cause a payout to be paid to the first user based on the first purchase and determining that first possible future market has occurred.

2. The apparatus of claim 1, in which the plurality of users is comprised by a second user and a third user, in which the instructions, when executed by the at least one processor, further direct the at least one processor to: receive from the second user a request to purchase shares mutually exclusive to a purchase of a third user, in which the request comprises a request to sell against a purchase of the third user; based on the request to sell against the third user, transmit to the third user a request to make a purchase mutually exclusive to a purchase of the second user; and receive from the third user an acceptance of the request to make a sell mutually exclusive to a purchase of the second user, in which the acceptance comprises a selection by the third user of a possible future state that is mutually exclusive to a possible future market selected by the second user.

3. The apparatus of claim 1, in which the first possible future market is comprised from at least one of the following: the artist's music, the artist's social media following, the artist's political views, the artist's statements about another, the artist's latest purchase, the artist's latest tattoo, the artist's videos posted online, the artist's pregnancy, the artist's wedding, the artist's divorce and/or the artist's death.
